(19) United States
(12) Patent Application Publication
(10) Pub. No.: US 2009/0251484 A1
(43) Pub. Date: Oct. 8, 2009

(54) AVATAR FOR A PORTABLE DEVICE

(75) Inventors: Ming-Xi Zhao, Shanghai (CN); Jian-Cheng Huang, Shanghai (CN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/062,098

(22) Filed: Apr. 3, 2008

(51) Int. Cl. G09G 5/02

(52) U.S. Cl. 345/591; 345/581; 345/589; 345/592; 345/593; 348/552

(57) ABSTRACT

A portable device comprises a data storage for storing avatar data defining a user avatar. The user avatar is formed by a plurality of visual objects. The portable device further comprises a camera for capturing an image. A visual characteristic processor is arranged to determine a first visual characteristic from the image and an avatar processor is arranged to set an object visual characteristic of an object of the plurality of visual objects in response to the first visual characteristic. The invention may allow improved customization of user avatars. For example, a color of an element of a user avatar may be adapted to a color of a real-life object simply by a user taking a picture thereof.

### FIELD OF THE INVENTION

The invention relates to a portable device storing avatar data defining a user avatar and in particular, but not exclusively, to a portable communication device such as a cellular mobile phone.

### BACKGROUND OF THE INVENTION

The increasing variety, availability, and popularity of communication and computer consumer devices have in recent years led to a number of new applications and services being provided to users. For example, online gaming, such as in multi-user games, have become popular as have various new communication services including instant messaging and chat services.

In many such new services and applications, the user may be represented by an avatar. An avatar provides a virtual representation of a user in the form of a visual model. The model is typically a graphical model and may, e.g., be a three-dimensional model, as used in many multi-user computer games, or a two-dimensional image, as is often used for communication services and online communities such as Internet forums or social networking websites.

A user avatar can for example be generated from a number of predefined components. For example, the user can select different components to make up his avatar and may in many cases also be able to select different characteristics for each component from a predefined database. Thus, in many applications a customized avatar can be generated by the user thereby allowing the avatar to be personalized to the specific preferences of the user. However, although the selection of predefined components and characteristics allows some personalization, the degree of personalization is relatively limited. However, as the avatar represents the user's identity, there is a significant desire to provide options for further personalization and customization of the avatar.

Hence, an improved approach for modifying avatars would be advantageous, and in particular a system allowing increased flexibility, improved personalization, facilitated implementation, facilitated operation, or an improved user experience or satisfaction would be advantageous.

### BRIEF SUMMARY OF THE INVENTION

Accordingly, the invention seeks to mitigate, alleviate, or eliminate one or more of the above mentioned disadvantages singly or in any combination.

According to an aspect of the invention there is provided a portable device comprising: a data storage for storing avatar data defining a user avatar, the user avatar being formed by a plurality of visual objects; a camera for capturing an image; a first unit for determining a first visual characteristic from the image; and a second unit for setting an object visual characteristic of an object of the plurality of visual objects in response to the first visual characteristic.

The invention may allow an improved or facilitated modification of a user avatar and may in particular allow increased personalization or customization of an avatar. The invention may allow improved user satisfaction for a number of services and applications using avatars to represent users.

In particular, portable devices with built-in cameras may be used to easily and efficiently adapt visual characteristics of an avatar to real-world visual characteristics encountered by the user. The avatar may, e.g., be modified in real time and may in particular be modified directly as and when the user identifies a real-life object based on which he would like to customize the avatar.

For example, the invention may in many embodiments allow the user to simply point the camera to any real-life object and press a button in response to which one or more elements of the avatar may directly be customized to one or more visual aspects of the real-life object. The system may, e.g., allow a color, texture, or pattern of an object of the avatar to be set to correspond to a color, texture, or pattern of a real-life object.

The avatar may be a two-dimensional (2D) or three-dimensional (3D) object. For example, a surface visual characteristic of a 3D object of a 3D avatar may be set in response to the first visual characteristic.

The portable device may be any device suitable for carrying by the user. In particular, the portable device may have dimensions of less than 15 cm by 10 cm by 5 cm. Thus, the invention may allow a small device which is convenient for the user to carry at all times to be used to adapt the user avatar as and when the user encounters real-life objects that he would like to base an avatar customization on. In particular, the portable device may be a mobile phone. This may provide a high degree of user satisfaction as a device mainly aimed at providing other services (namely communication services) and frequently carried by the user for these reasons can also be used to provide the user with a potentially continuous opportunity to adapt an avatar to real-life objects the user may come across.

According to another aspect of the invention there is provided a method of operation for a portable device having a camera, the method comprising: storing avatar data defining a user avatar, the user avatar being formed by a plurality of visual objects; the camera capturing an image; determining a first visual characteristic from the first image; and setting an object visual characteristic of an object of the plurality of visual objects in response to the first visual characteristic.

These and other aspects, features and advantages of the invention will be apparent from and elucidated with reference to the embodiments described hereinafter.

### BRIEF DESCRIPTION OF THE SEVERAL VIEWS OF THE DRAWINGS

Embodiments of the invention will be described, by way of example only, with reference to the drawings, in which:

FIG. 1 is an illustration of an example of a portable device in accordance with some embodiments of the invention;

FIG. 2 is an illustration of an example of a customization of an avatar by a portable device in accordance with some embodiments of the invention; and

FIG. 3 is an illustration of an example of a flowchart of a method of operation for a portable device in accordance with some embodiments of the invention.

### DETAILED DESCRIPTION OF THE INVENTION

The following description focuses on embodiments of the invention applicable to a portable communication device and in particular to a cellular mobile telephone. However, it will be appreciated that the invention is not limited to this application but may be applied to many other portable devices including, for example, digital photo cameras or personal digital assistants (PDAs).

In recent years the popularity of applications and services wherein relatively large numbers of users can interact via electronic communication means has increased substantially. Such applications and services may generate electronic or virtual user communities, e.g., allowing users to interact in a virtual world. Examples of such services and applications include chat services and multi-user online games.

In such applications and services, it is common for a user to be represented by a user avatar which may be a two- or three-dimensional graphical entity. For example, in many chat services a two-dimensional graphical image is used to represent the user, and in many virtual world multi-user online games, a three-dimensional graphical model of a fictional or non-fictional being is used to represent the user.

As the user avatar is a personal representation of the user, it is desirable that the user avatar can be personalized and customized to the individual user. In many applications, the user can generate the desired user avatar himself by manually specifying various characteristics of the user avatar. As a simple example, the user may select his user avatar from a number of predefined avatars. However, in many applications and services, a number of different individual objects or components may be predefined, and a user may generate his user avatar by selecting and combining individual objects and components from the predefined sets. For example, for a user avatar corresponding to a graphical representation of a face, the user may individually select, e.g., eyes, eyebrows, nose, mouth, hair, ears, etc., from predefined sets of eyes, eyebrows, nose, mouth, hair, ears, etc.

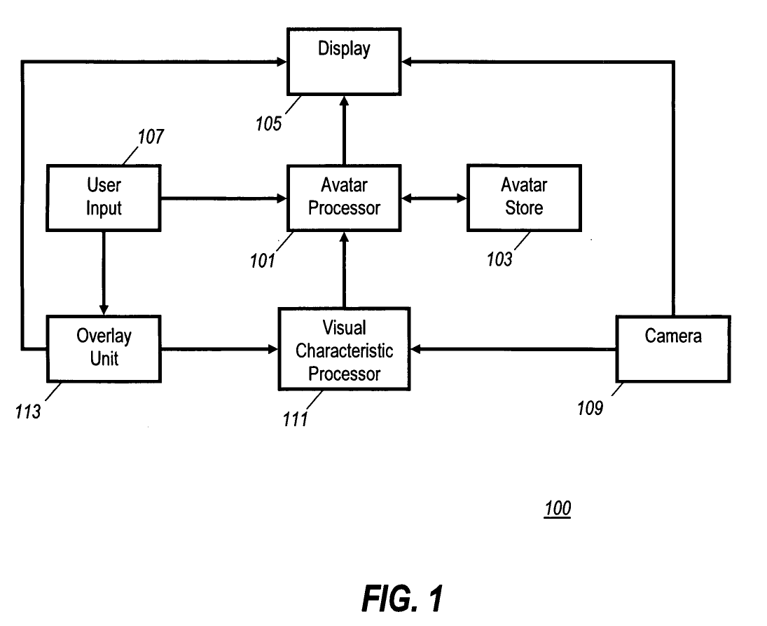

FIG. 1 illustrates an example of a portable device in accordance with some embodiments of the invention. In the specific example, the portable device is a cellular mobile phone, such as a Global System for Mobile communication (GSM) mobile terminal or Universal Mobile Telecommunications System (UMTS) user equipment.

The mobile phone of FIG. 1 is arranged to provide additional functionality for providing an improved adaptation and customization of a user avatar. In particular, the mobile phone comprises functionality for allowing visual characteristics to be adapted in response to visual characteristics from real-life objects.

The mobile phone comprises an avatar processor 101 which is arranged to manage a user avatar which may be used by various applications and services supported by the mobile phone. For example, the user avatar may be used for a chat service supported by the operator of the cellular communication system or may be used when the user plays an Internet online game over the Internet. In some embodiments, the user avatar may not be used by the mobile phone itself but rather the avatar data may be communicated to another device, such as a computer, which executes an application using the avatar.

The avatar processor 101 is coupled to an avatar store 103 which can store various avatar data. The avatar processor 101 is furthermore coupled to a display 105 and a user input 107. The display 105 and user input 107 are used to provide a user interface to the user of the mobile phone.

In the example, the user may generate a user avatar by selecting visual objects for the user avatar from a set of predefined visual objects (components) as well as optionally specific characteristics for each object (e.g., color). The components or visual objects are specifically represented as data that characterize a visual representation of the object.

For example, the user may on the display 105 be presented with various options and may enter his selection via the user input 107. This selection process is controlled by the avatar processor 101 and can be used to define an avatar for the user. Thus, in the example, the avatar store 103 may comprise an initial database of predefined avatar objects, and the avatar processor 101 may retrieve these in a suitable order, present them to the user via the display 105, and receive the user's selection via the user input 107. The avatar processor 101 then generates avatar data that define the user avatar. For example, the avatar data for an avatar may include an identification of the objects used to make up the avatar, the interrelation between these objects (e.g., their relative or absolute position), as well as characteristics of the individual objects (e.g., the color of an object). The avatar data defining the user avatar are then stored in the avatar store 103.

As a specific example, the user may first select whether he wants to create a 2D or 3D avatar. After this selection, the avatar processor 101 may retrieve the predefined options for creating the selected type of avatar. For example, the user may be asked whether he wants to create a full body avatar or a face avatar. The creation process may then proceed by the user being asked to make further selections suitable for the specific avatar. For example, for a face avatar, the user may on the display be presented with the predefined options for eyes. After selection of a suitable set of eyes and appropriate characteristics thereof (e.g., the color of the selected eyes), the user is asked for selection of the next object (e.g., to select a nose for the face avatar). The process may be repeated until a suitable user avatar has been generated.

Although this approach allows a high degree of personalization and customization of the individual avatar, the mobile phone of FIG. 1 comprises functionality that allows a further customization of the avatar. Specifically, the mobile phone allows one or more characteristics of one or more objects of the defined avatar to be adapted or modified to match a characteristic of a real-life object.

In particular, the mobile phone of FIG. 1 comprises a camera 109 which is operable to capture an image. In the specific example, the camera 109 is a still-image camera, but it will be appreciated that in other embodiments, a moving-image camera capturing a video sequence may be used.

The camera 109 is coupled to a first processor 111 which is operable to determine a first visual characteristic from the first image. For example, the visual characteristic processor 111 may process the captured image to determine a dominant color, e.g., the image may be a close up of a visual object which has a color that the user would like to apply to an object of the user avatar. Accordingly, the visual characteristic processor 111 may analyze the image to find the largest contiguous image segment (e.g., the largest image region in which the color variation is within a given interval). The dominant color may then be determined as the average of that image segment.

The determined visual characteristic is fed to the avatar processor 101 which is arranged to set an object visual characteristic of one or more objects making up the user avatar in response to the determined visual characteristic. For example, the avatar processor 101 may set the visual characteristic of one or more of the objects to a visual characteristic from a real-life object. For example, the skin color of a face avatar may be set to correspond directly to a skin tone of the user as captured by an image of the user.

Thus, the mobile phone of FIG. 1 may provide an attractive feature for users when customizing an avatar. In particular an improved or facilitated customization may be achieved. Furthermore, as the functionality is embedded in a portable device, an efficient, practical, and real-time customization can be achieved without relying or requiring access to any other devices and in particular without requiring access to an image database or central server. Rather, a simple portable device, such as a mobile phone, which is frequently carried by a user for other purposes (e.g., for communication purposes), can also be used to customize a user avatar to real-world visual characteristics as and when the user encounters these characteristics. For example, a user can immediately and in real time modify a visual characteristic of a user avatar to a real-life visual characteristic when he comes across a suitable real-life object. Furthermore, for many portable devices, such as mobile phones, the additional cost and complexity of the added functionality is negligible because such devices typically already comprise camera functionality.

As a specific example, the approach may provide a feature allowing a user who wants to change the color of an avatar feature to the color of a real-life object to simply point the camera in the direction of the real-life object and take a photo. The color of the avatar feature is then automatically and instantly changed to the color of the real-life object.

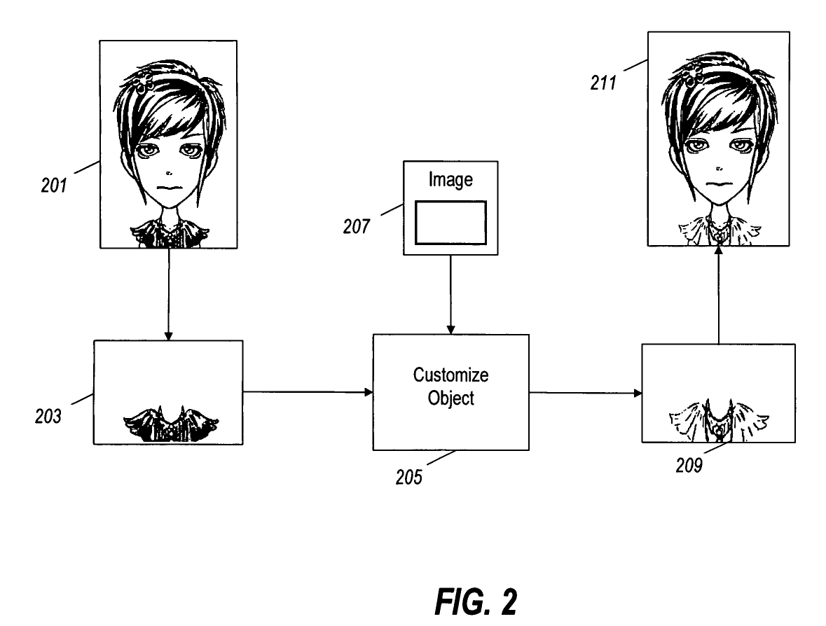

FIG. 2 shows an example of how the color of a visual object of a face avatar 201 can be adapted by the portable device of FIG. 1.

Initially, the avatar processor 101 selects an object 203 of the user avatar 201 to be modified. The selection of the object may for example be by the user selecting an object from the objects forming the avatar. In the example, the shade of the selected object 203 is then customized 205 in response to a shade extracted from an image 207 captured by the camera 109. As a result, a modified object 209 is generated with the shade corresponding to the detected shade in the image 207. A modified avatar 211 is then generated by replacing the original selected object 203 by the modified object 209.

In the specific example, the portable device can specifically change a color characteristic, a texture characteristic, or a pattern characteristic of one or more of the objects in response to a corresponding characteristic detected in the image.

For example, the visual characteristic processor 111 can detect a color, a texture (color variation), or a pattern in a specific image area selected by the user. Accordingly, the color of the object can be set to the detected color, or the texture of the object can be set to the detected texture, or the pattern of the object can be set to the detected pattern. As a specific example, the visual characteristics of the object may be set to reflect the detected color, the detected texture, and the detected pattern of the selected image area.

The portable device of FIG. 1 furthermore comprises an overlay unit 113 which is coupled to the display 105, to the user input 107, and to the visual characteristic processor 111. The overlay unit 113 is arranged to overlay the camera image being presented on the display 105 with a marker.

Specifically, when the user selects the described avatar customization feature, the live real-time image captured by the camera 109 is shown on the display 105. In addition, the overlay unit 113 generates a visual marker which is overlayed on the presented camera image. For example, a marker may be overlayed in the center of the display.

When an image is captured, e.g., by the user pressing an appropriate button, the visual characteristic processor 111 proceeds to determine the first visual characteristic, and specifically the characteristic is determined for an image region associated with the marker. Thus, the marker overlayed on the camera image identifies the area of the image that will be used to modify the avatar object thereby allowing the user to accurately point the camera 109 towards the desired real-life object.

In the described example, the overlay unit 113 is furthermore arranged to set an appearance of the marker in response to a type of the object visual characteristic which is to be captured. Specifically, a different marker may be used depending on whether the user is interested in modifying the color or the pattern or texture of the object.

In the example, the overlay unit 113 specifically uses a smaller marker when customizing a color characteristic than when customizing a pattern or texture characteristic. Thus, the image region indicated by the marker is smaller for a color characterization than for a texture or pattern and may in particular be a single image location or pixel.

Furthermore, the image region which is used to determine the visual characteristic for the customization corresponds to the marker appearance. Thus, the image region used to determine the color characteristic from the image is smaller than the image region used to determine a texture or pattern characteristic.

As a specific example, when a color customization is selected by the user, a marker in the form of a cross-hair shape may be overlayed on the real-time camera image on the display 105. When the image is captured, the visual characteristic processor 111 can proceed to determine the color at the center of the cross-hair marker and use this color to customize the avatar object. Specifically, the color of a single image element or pixel at the center of the cross hair may be used (corresponding to an image region of a single pixel).

However, if pattern or texture customization is selected, a marker having a larger area is overlayed on the real-time camera image. For example, a rectangle or circle covering, e.g., 20-50% of the central part of the image may be overlayed on the image. Accordingly, when the image is captured, the visual characteristic processor 111 proceeds to determine the pattern or texture in this image area.

Thus, the marker may be adjusted to reflect characteristics of the specific visual characteristic that is captured and customized. In particular, as texture and pattern inherently relate to image areas whereas a color characteristic can relate to a specific image location, this allows an improved customization and allows the user to more accurately capture a suitable image for a specific purpose.

It will be appreciated that in some embodiments, the user may be able to select between different markers for the same type of customization. For example, for a pattern customization, the user may be able to select between different size markers or different locations of the markers. This may allow the user to more accurately select the region that is used to determine the real-life visual characteristic and may in particular allow this to be adapted to the specific image and the constraints and limitations associated therewith.

In some embodiments, the selection of the marker may not only select the image region used for determining the visual characteristic but may alternatively or additionally be used as a selection of the type of customization. For example, if the user selects a cross-hair marker a color customization is performed, if the user selects a rectangular-area marker a pattern customization is performed, and if the user selects a circular-area marker a texture customization is performed.

In some embodiments, the avatar processor 101 may be arranged to process the visual characteristic received from the visual characteristic processor 111 before it is applied to the avatar object.

For example, in some embodiments, the determined visual characteristic may comprise a color indication for a plurality of image locations. For example, within a selected area some image locations may be selected or indeed all pixels within the image area may be selected by the avatar processor 101. The avatar processor 101 may then average the color values for the image locations to generate an average color value. This averaged color value may then be applied as the color of the avatar object being customized. This may in many scenarios provide an improved customization and may for example reduce the sensitivity of the applied color to color variations in an image area to which the user wants customization.

In some embodiments, the avatar processor 101 may be operable to convert the determined color characteristic from a non-perception-based color space to a perception-based color space prior to determining the color which is applied to the avatar object. For example, before performing the previously described averaging, the avatar processor 101 may convert the color values of the selected image points from a non-perception-based color space (such as a Red Green Blue (RGB) color space) into a perception-based color space (such as a Lab color space or a Luv color space as defined by the International Commission on Illumination). The averaging of the color values may then be performed in the perception-based color space.

Depending on the requirements for the avatar data, the averaged color value may then be converted back to the non-perception-based color space before being applied to the avatar object.

Such an approach may provide an improved customization wherein the color manipulation more closely reflects how the user will perceive the colors.

In some embodiments, the avatar processor 101 is operable to determine a color variation characteristic for the avatar object. In particular, the avatar processor 101 may determine a current average color of the object by averaging all color values assigned to the object. For example, for an object having a colored texture, the average color is determined.

The color variation characteristic is then determined by removing an average color from the color pattern of the object. Specifically, for all elements (e.g., all pixels) of an object, the average color value may be subtracted from the color value of the element (e.g., pixel). The resulting values thus reflect the color variation across the object. As another example, the mean and the standard deviation for the avatar object can be determined.

The avatar processor 101 can then proceed to change the average color characteristic for the object depending on the color determined in response to the captured image while at the same time maintaining the determined color variation characteristic for the object.

For example, the determined new average color value may simply be added to all the color values resulting from subtracting the previous average color value of the object. Thus, the average color of the object may be changed whereas the variance and standard deviation of the color of the object may be maintained.

Such an approach may provide a desirable feature in many scenarios and may specifically allow a color customization of an object while maintaining the texture of the object.

In some scenarios, the avatar processor 101 may be operable to determine separate visual characteristics for a plurality of image segments within a selected image region. For example, a marker overlaying a rectangular area of, say, 40% of the image may be used to select an image region.

The visual characteristic processor 111 may then proceed to identify different image segments within the selected region. It will be appreciated that a number of different image segmentation techniques and algorithms will be known to the person skilled in the art and that any suitable algorithm may be used without detracting from the invention.

The visual characteristic processor 111 may then proceed to determine individual and separate visual characteristics for each image area corresponding to an image segment. For example, the visual characteristic processor 111 may determine an average color for each of the areas or image segments.

The determined visual characteristics are then fed to the avatar processor 101 which in the specific example is also fed the image segmentation data, i.e., the avatar processor 101 receives information of the different identified image segments. This information may for example define the size of each object and the relative position of the objects.

In response, the avatar processor 101 proceeds to divide the object into areas that correspond to the identified image segments, and it then proceeds to set a visual characteristic for each area in response to the received visual characteristic for the corresponding image segment.

Such an approach may allow improved or facilitated customization of an avatar. For example, it may allow the object to reflect variations of the real-life object to which the user wants to customize. For example, the feature may allow a user to capture an image of a polka-dot-patterned clothing item in order to modify an object of an avatar to have the same polka-dot pattern with the same colors.

In some embodiments, the visual characteristic processor 111 may be able to determine an image region size characteristic, and the avatar processor 101 may be arranged to adapt an object size characteristic for the object in response thereto.

For example, the user may capture an image of a face, and image-segmentation and image-object-recognition algorithms may be applied to determine image areas corresponding to eyes, nose, mouth, ears, etc. The size of each of these image areas may accordingly be determined, and the size of corresponding avatar objects of a face avatar may be adapted accordingly. Thus, this approach may allow an easy adaptation of the relative size of a face avatar's eyes, nose, mouth, ears, etc., to the corresponding dimensions of a real person.

It will be appreciated that in other embodiments, other portable devices than a mobile phone may be used. The portable devices may specifically be sufficiently small to allow them to be carried in a pocket or small handbag thereby allowing the user to easily carry the portable device. Specifically, the device may have dimensions of less than 15 cm by 10 cm by 5 cm and may weigh less than 500 g.

Implementing the described functionality in such small devices may allow the user to typically be carrying the device. Indeed, in the case of, e.g., a mobile phone, the portable device will typically be carried by the user in order to be able to always access communication services. Thus, the implementation of the functionality in a small portable device such as a mobile phone provides the user with a possibility of adapting an avatar to real-life objects whenever a suitable object is encountered. Thus, a highly flexible, easy to use, and convenient ability to customize an avatar is acquired without requiring a user to carry or have access to any other devices than what is typically carried by a user for other purposes.

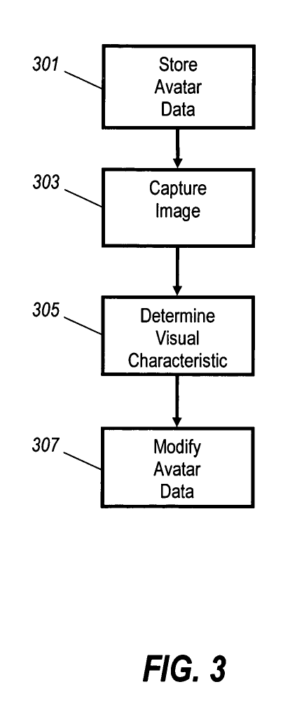

FIG. 3 illustrates an example of a flowchart of a method of operation for a portable device having a camera in accordance with some embodiments of the invention.

The method initiates in step 301 wherein avatar data defining a user avatar are stored. The user avatar is formed of a plurality of visual objects (or components).

Step 301 is followed by step 303 wherein an image is captured by the camera.

Step 303 is followed by step 305 wherein a visual characteristic is determined from the image captured by the camera.

Step 305 is followed by step 307 wherein an object visual characteristic of an object of the plurality of visual objects making up the avatar is set in response to the visual characteristic.

It will be appreciated that the above description for clarity has described embodiments of the invention with reference to different functional units and processors. However, it will be apparent that any suitable distribution of functionality between different functional units or processors may be used without detracting from the invention. For example, functionality illustrated as performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware, or any combination of these. The invention may optionally be implemented at least partly as computer software running on one or more data processors or digital signal processors. The elements and components of an embodiment of the invention may be physically, functionally, and logically implemented in any suitable way. Indeed the functionality may be implemented in a single unit, in a plurality of units, or as part of other functional units. As such, the invention may be implemented in a single unit or may be physically and functionally distributed between different units and processors.

The described functionalities, processors, means, or units may as appropriate, e.g., be implemented as executable routines implemented in a processing unit such as a micro-controller, a digital signal processor, or a central processing unit. Specifically, the functionality of different illustrated processors, means, and units may as appropriate be implemented as one or more subroutines executed on the same processing unit.

The means, functionality, processors, and units illustrated in the figures may thus as appropriate be implemented as different unique sets of programming instructions that are executed on one processor (or distributed over a plurality of processors), or can each be electronic circuitry such as a custom large-scale integrated circuit state machine (or part of one). As another example, the means, functionality, processors, and units may be implemented partly or fully as neural networks or via fuzzy computing.

Also, the memory or data stores may be implemented as suitable memory elements, such as solid state memory (ROM, RAM, flash memory, etc), magnetic, or optical storage devices (hard disk, optical disc, etc).

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, or method steps may be implemented by, e.g., a single unit or processor. Additionally, although individual features may be included in different claims, these may possibly be advantageously combined, and the inclusion in different claims does not imply that a combination of features is not feasible or advantageous. Also, the inclusion of a feature in one category of claims does not imply a limitation to this category but rather indicates that the feature is equally applicable to other claim categories as appropriate. Furthermore, the order of features in the claims does not imply any specific order in which the features must be worked, and in particular the order of individual steps in a method claim does not imply that the steps must be performed in this order. Rather, the steps may be performed in any suitable order.

We claim:

1. A portable device comprising:
a data storage for storing avatar data defining a user avatar, the user avatar comprising a plurality of visual objects;
a camera for capturing an image;
a first unit for determining a first visual characteristic from the image; and
a second unit for setting an object visual characteristic of an object of the plurality of visual objects in response to the first visual characteristic.

2. The portable device of claim 1 wherein the first visual characteristic comprises a first color characteristic, and wherein the object visual characteristic comprises a second color characteristic.

3. The portable device of claim 2 wherein the second unit is arranged to generate a third color characteristic by converting the second color characteristic from a non-perception-based color space to a perception-based color space and to set the first color characteristic in response to the third color characteristic.

4. The portable device of claim 2 wherein the second unit is arranged to determine a color variation characteristic for the object and to set an average color characteristic for the object in response to the second color characteristic while maintaining the color variation characteristic for the object.

5. The portable device of claim 4 wherein the second unit is arranged to determine an average color of the object prior to setting the first color characteristic and to generate the color variation characteristic by removing an average color from a color pattern of the object prior to setting the first color characteristic.

6. The portable device of claim 2 wherein the first unit is arranged to generate the second color characteristic as an average color of colors of a plurality of selected image locations of the image.

7. The portable device of claim 1 wherein the first visual characteristic comprises a first pattern characteristic, and wherein the object visual characteristic comprises a second pattern characteristic.

8. The portable device of claim 1 wherein the first visual characteristic comprises a first texture characteristic, and wherein the object visual characteristic comprises a second texture characteristic.

9. The portable device of claim 1 further comprising:
an overlay unit for overlaying a camera image with a marker;
wherein the first unit is arranged to determine the first visual characteristic as a visual characteristic of an image region associated with the marker.

10. The portable device of claim 9 wherein the camera image is a real-time camera image, and wherein the first unit is arranged to determine the first visual characteristic in response to a characteristic of the image region when the real-time camera image is captured.

11. The portable device of claim 9 wherein the overlay unit is arranged to set an appearance of the marker in response to a type of the object visual characteristic.

12. The portable device of claim 9 wherein the overlay unit is arranged to set an appearance of the marker to have a smaller size when the object visual characteristic is a color characteristic than when the object visual characteristic is at least one of a pattern characteristic and a texture characteristic.

13. The portable device of claim 9 further comprising:
a user input for receiving an input from a user;
wherein the overlay means is arranged to select a marker appearance in response to the input from the user; and
wherein the first unit is arranged to select between a plurality of types of the first visual characteristic in response to the selection of the marker appearance.

14. The portable device of claim 1 wherein the first unit is arranged to determine the first visual characteristic in response to a visual characteristic of an image region of the image.

15. The portable device of claim 14 wherein the first unit is arranged to determine a plurality of image segments in the image region, and wherein the first visual characteristic comprises a visual characteristic for at least two image segments of the plurality of image segments.

16. The portable device of claim 15 wherein the second unit is arranged to divide the object into a plurality of areas and to set a visual characteristic of each area of the plurality of areas in response to a visual characteristic of an image segment of the at least two image segments.

17. The portable device of claim 16 wherein the first visual characteristic comprises segment data characterizing the plurality of image segments; and
wherein the second unit is arranged to divide the object into the plurality of areas in response to the segment data.

18. The portable device of claim 1 wherein the first visual characteristic comprise a first image region size characteristic, and wherein the object visual characteristic comprises an object size characteristic.

19. The portable device of claim 1 wherein the portable device is a mobile telephone.

20. A method of operation for a portable device having a camera, the method comprising:
storing avatar data defining a user avatar, the user avatar comprising a plurality of visual objects;
the camera capturing an image;
determining a first visual characteristic from the first image; and
setting an object visual characteristic of an object of the plurality of visual objects in response to the first visual characteristic.
